(19) United States
(12) Patent Application Publication
(10) Pub. No.: US 2007/0226806 A1
(43) Pub. Date: Sep. 27, 2007

(54) Method and apparatus for enhancing cryptographic engines against security attacks

(76) Inventors: Lihui Tung, Portland, OR (US); Dhiraj U. Bhatt, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/390,949

(22) Filed: Mar. 27, 2006

(51) Int. Cl. H04L 9/32; G06F 12/14; H04L 9/00; G06F 17/30; G06F 7/04; G06F 11/30; G06K 9/00; H03M 1/68; H04K 1/00; H04N 7/16

(52) U.S. Cl. 726/27; 713/189; 713/193; 380/284

(57) ABSTRACT

Apparatus, systems and methods for enhancing cryptographic engines against attack are disclosed. In one implementation, a method is disclosed including limiting a cryptographic device to a first number of cryptographic operations, and reconfiguring the cryptographic device to limit the cryptographic device to a second number of cryptographic operations. Additional implementations are disclosed.

### BACKGROUND

Cryptographic modules (CMs) employing cryptographic engines (CEs) are commonly used to provide for the encryption and decryption of audio and visual content. Typically, a CM can, on request from an application, use an internal random number generator in conjunction with a secret, on-chip root key to generate one or more storage keys. These storage keys may then be used by the CE to encrypt secrets provided by the application. The storage keys may then be stored in the CM's internal cache memory while the encrypted secrets and associated encrypted storage keys are typically stored in external memory. The secrets are frequently platform specific and may include, among other things, license keys and a unique platform identifier.

Typically, the root key and the key cache are shielded from direct attack by security threats because they are inaccessible to devices external to the CM. However, as long as the encrypted secrets and associated encrypted storage keys are held in external memory they may be used, in conjunction with a typical CM, to expose the secrets and/or storage keys. For example, using a brute force approach a malevolent entity may repeatedly pass carefully chosen text data to a typical CM, request that the CM encrypt the plain text data with the storage keys or secrets, and then compare the encrypted results with the encrypted secrets and associated encrypted storage keys to expose the secrets and/or storage keys.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 illustrates an example cryptographic processing system in accordance with some implementations of the invention;

FIG. 2 illustrates portions of the system of FIG. 1 in more detail;

FIG. 3 is a flow chart illustrating an example process for enhancing cryptographic engines against security attacks in accordance with some implementations of the invention; and

FIG. 4 is a flow chart illustrating, in greater detail, portions of the example process of FIG. 3 for enhancing cryptographic engines against security attacks in accordance with some implementations of the invention.

### DETAILED DESCRIPTION

The following description refers to the accompanying drawings. Among the various drawings the same reference numbers may be used to identify the same or similar elements. While the following description provides a thorough understanding of the various aspects of the claimed invention by setting forth specific details such as particular structures, architectures, interfaces, techniques, etc., such details are provided for purposes of explanation and should not be viewed as limiting. Moreover, those of skill in the art will, in light of the present disclosure, appreciate that various aspects of the invention claimed may be practiced in other examples or implementations that depart from these specific details. At certain junctures in the following disclosure descriptions of well known devices, circuits, and methods have been omitted to avoid clouding the description of the present invention with unnecessary detail.

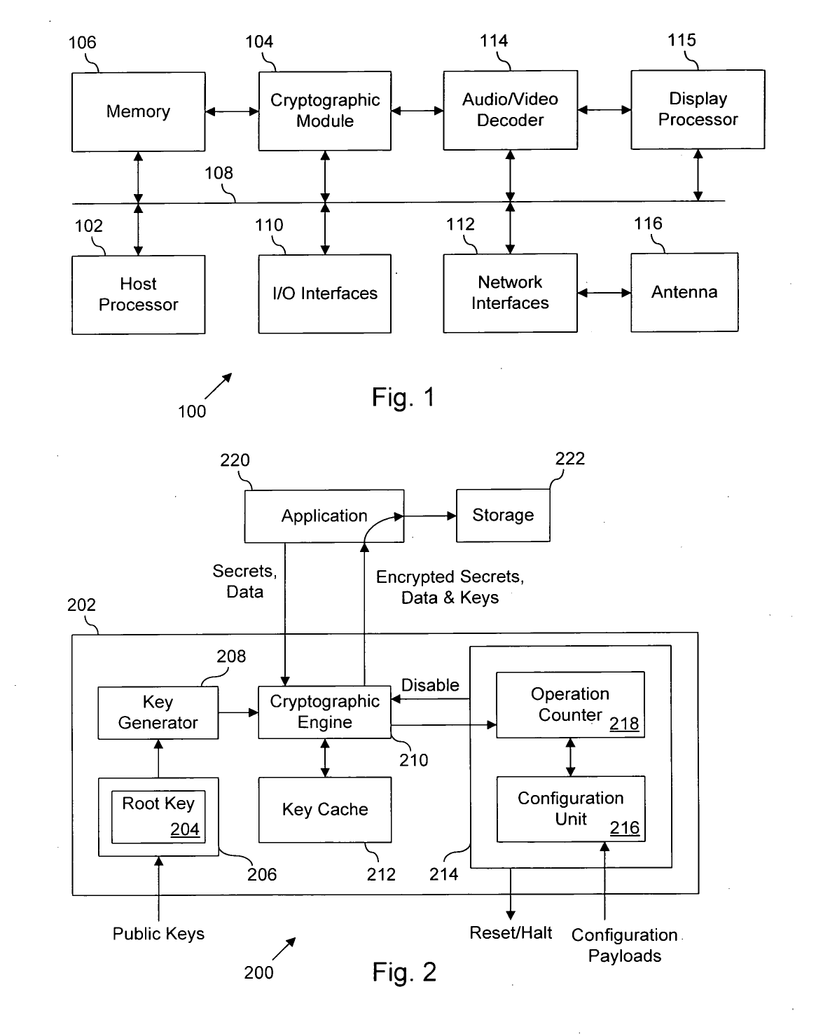

FIG. 1 illustrates an example system 100 according to some implementations of the invention. System 100 may include a host processor 102, a cryptographic module (CM) 104, memory 106 (e.g., dynamic random access memory (DRAM), static random access memory (SRAM), flash, etc.), a bus or communications pathway(s) 108, input/output (I/O) interfaces 110 (e.g., universal synchronous bus (USB) interfaces, parallel ports, serial ports, telephone ports, and/or other I/O interfaces), network interfaces 112 (e.g., wired and/or wireless local area network (LAN) and/or wide area network (WAN) and/or personal area network (PAN), and/or other wired and/or wireless network interfaces), a audio/video (A/V) decoder 114, and a display processor and/or controller 115. System 100 may also include an antenna 116 (e.g., dipole antenna, narrowband Meander Line Antenna (MLA), wideband MLA, inverted “F” antenna, planar inverted “F” antenna, Goubau antenna, Patch antenna, etc.) coupled to network interfaces 112.

System 100 may be any system suitable for cryptographically processing data (e.g., content such as text, audio, or image data) and providing that data to devices suited to reproducing the audio and/or visual content in a format suitable for presentation on an external device (not shown) such as a liquid crystal display (LCD), or a plasma display panel (PDP) display to name a few examples. Further, system 100 may assume a variety of physical implementations. For example, system 100 may be implemented in a set-top box (STB), a personal computer (PC), a networked PC, a server computing system, a handheld computing platform (e.g., a personal digital assistant (PDA)), a handheld communication platform (e.g., a cellular telephone handset), etc.

While all components of system 100 may be implemented within a single device, such as a system-on-a-chip (SOC) integrated circuit (IC), components of system 100 may also be distributed across multiple ICs or devices. For example, host processor 102, CM 104, memory 106, and A/V decoder 114 may be implemented in one or more ICs contained within a single platform such as a STB while display processor 115 may be implemented in a separate device such as a display (not shown) coupled to elements 102-106, and 114 through communications pathway 108.

Host processor 102 may comprise a special purpose or a general purpose processor including any control and/or processing logic, hardware, software and/or firmware, capable of supporting enhancing cryptographic engines against security attacks in accordance with implementations of the invention. Including, for example, providing CM 104 with configuration payloads, public keys, encrypted data for decryption, secrets for encryption, etc, as will be explained in greater detail below. Software applications executing on processor 102 may undertake a variety of operations in conjunction with CM 104 related to enhancing cryptographic engines against security attacks, the results of which may be stored in memory 106 as will be explained in greater detail below.

Processor 102 may also be capable of initializing and/or configuring registers within decoder 114 and/or processor 115, interrupt servicing, providing a bus interface for uploading and/or downloading encrypted audio/visual content, etc, although the invention is not limited in this regard. Processor 102 may comprise two or more processor cores although the invention is not limited in this regard. While system 100 shows host processor 102, CM 104, decoder 114 and processor 115 as distinct components, the invention is not limited in this regard and those of skill in the art will recognize that processors 102 and 115, CM 104 and/or decoder 114 possibly in addition to other components of system 100 may be implemented within a single IC such as a Soc.

A/V decoder 114 may comprise any control and/or processing logic, hardware, software and/or firmware, capable of decoding decrypted audio and/or video content and providing that decoded content to other components in system 100 such as processors 102 and/or 115. Display processor 115 may comprise any control and/or processing logic, hardware, software and/or firmware, capable of processing decrypted content for display. Processor 115 may receive decrypted and decoded image data provided by host processor 102, memory 106, or A/V decoder 114 and process that data into a format suitable for display. In addition, display processor 115 may implement a variety of image processing functions such as image scaling, alpha blending, etc.

Bus or communications pathway(s) 108 may comprise any mechanism for conveying information (e.g., encrypted content, keys, etc.) between or amongst any of the elements of system 100. For example, although the invention is not limited in this regard, communications pathway(s) 108 may comprise a multipurpose bus capable of conveying, for example, instructions (e.g., macrocode) between processor 102 and decoder 114, or configuration payloads between processor 102 and CM 104. Alternatively, pathway(s) 108 may comprise a wireless communications pathway.

CM 104 may comprise any processing logic, hardware, software, and/or firmware, capable of enhancing cryptographic engines against security attacks in accordance with some implementations of the invention. As will be explained in greater detail below, CM 104 may receive signed configuration payloads from processor 102, or other devices within system 100 or external to system 100, and may, upon verification of the authenticity of that payload, be configured or reconfigured in response to the content of the configuration payload in accordance with some implementations of the invention. CM 104 may further be capable of decrypting encrypted data and of providing the resulting unencrypted data to A/V decoder 114.

FIG. 2 is a simplified block diagram of a system 200 for use in enhancing cryptographic engines against security attacks in accordance with some implementations of the invention where system 200 includes a CM 202, such as CM 104 of system 100. CM 202 includes a root key 204 stored within a One-Time Programmable (OTP) non-volatile memory 206, a key generator 208, a cryptographic engine (CE) 210, a key cache 212, and a limiter module (LM) 214 including a configuration unit 216 and an operation counter 218. In some implementations, CM 202 may be implemented as an IC housed in, for example, a cellular telephone handset, a handheld computing device, a STB, a PC, a television, etc. However, the invention is not limited in this regard and the various elements of CM 202 may be distributed across two or more ICs and/or need not be implemented in a single device such as STB or a television. Although FIG. 2 shows root key 204 held in OTP 206, the invention is not limited in this regard, and those skilled in the art will recognize that root key 204 could be held securely in CM 202 using other means such as storing root key 202 in polysilicon fuses or read-only memory or logic gates, etc.

FIG. 2 also illustrates an application 220, such as might be executing on a processor such as host processor 102 of FIG. 1, providing data and/or secrets to CM 202 for encryption or decryption. CM 202 may employ key generator 208 to use root key 204 to generate storage keys, use CE 210 to encrypt the secrets with those storage keys and then store the encrypted secrets and encrypted storage keys in storage 222, such as memory 106 of FIG. 1. In accordance with some implementations of the invention, LM 214 of CM 202 may, in response to one or more configuration payloads, employ configuration unit 216 and operation counter 218 to enforce an operational limit on CE 210. The operational limit may place an upper limit on the number of times CE 210 may undertake cryptographic operations such as encrypting or decrypting data such as secrets provided by application 220 or other data supplied to CM 202.

In accordance with some implementations of the invention, LM 214 may, in response to CE 210 exceeding an operational limit, prevent CE 210 from encrypting or decrypting data by supplying a disable signal to CE 210. LM 214 may also, in accordance with some implementations of the invention and in response to CE 210 exceeding an operational limit, prevent applications, such as application 220, from requesting cryptographic services from CM 202 by providing a halt or reset signal to the host processor (e.g., host processor 102 of FIG. 1) supporting application 220. Further details of the cryptographic processes and/or functions of systems 100 and 200 will be described in greater detail below.

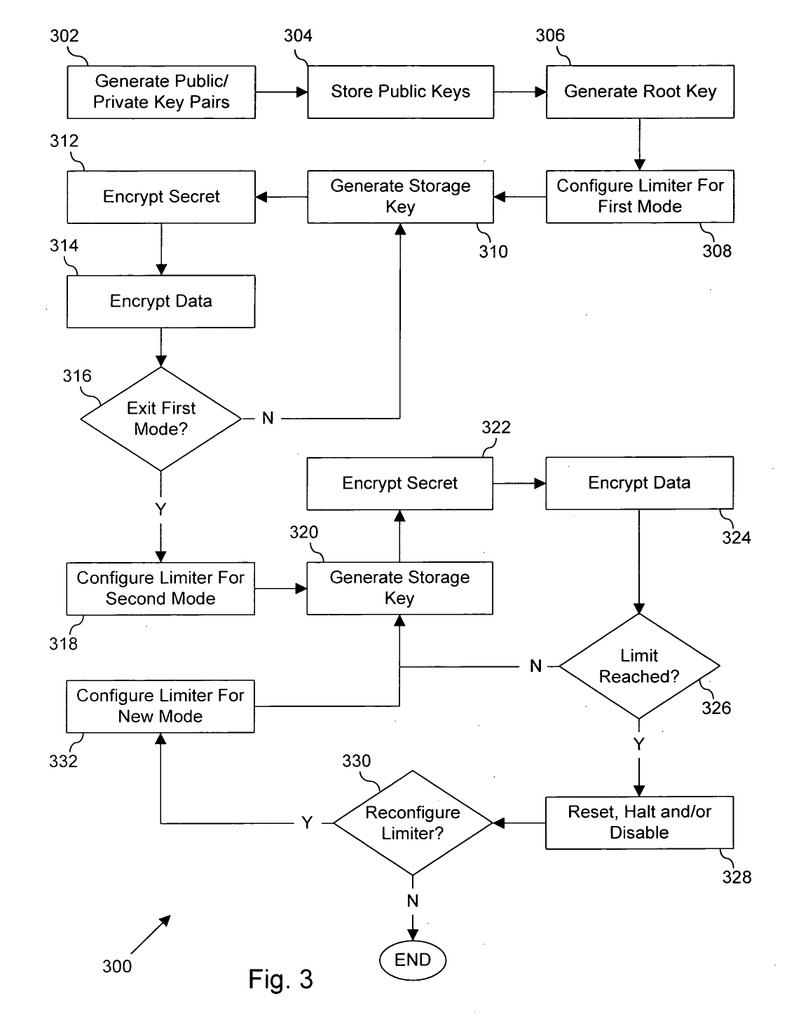

FIG. 3 is a flow diagram illustrating a process 300 for enhancing cryptographic engines against security attacks in accordance with some implementations of the invention. While, for ease of explanation, process 300, and associated processes, may be described with regard to systems 100 and 200 and components thereof shown in FIGS. 1 and 2 (such as CM 202 of FIG. 2), the invention is not limited in this regard and other processes or schemes supported and/or performed by appropriate devices and/or combinations of devices in accordance with the invention are possible. In addition, while process 300 will be described in the context of several modes for configuring cryptographic engines against security attacks the invention is not limited in this regard and contemplates no specific limit on the number or type of modes that a cryptographic engine may be placed in to enhance that engine against security attacks.

Process 300 may begin with the generation of public/private key pairs [act 302]. Act 302 may be undertaken by utilizing well known Public Key Infrastructure (PKI) techniques, such as the Rivest, Shamir, and Adelman (RSA) digital signature algorithm (DSA). For example, a manufacturer of system 100/200 may use PKI techniques to procure public/private key pairs. Process 300 may then continue with the storage of the public keys [act 304]. In some implementations of the invention, the manufacturer of system 100 may have processor 102 undertake act 304 by placing the public key of the public/private key pair generated in act 302 in OTP 206 of CM 202.

Process 300 may continue with the generation of a root key [act 306]. In some implementations of the invention this may be done by the manufacturer of system 100/200 having processor 104 store a previously generated root key in OTP 206. Once stored within CM 202 the root key may not, in accordance with some implementations of the invention, be visible and/or accessible to application 220 and/or other software executing on system 100/200 and/or external devices and/or systems through interfaces to system 100/200 such as Joint Test Action Group (JTAG) interfaces (not shown).

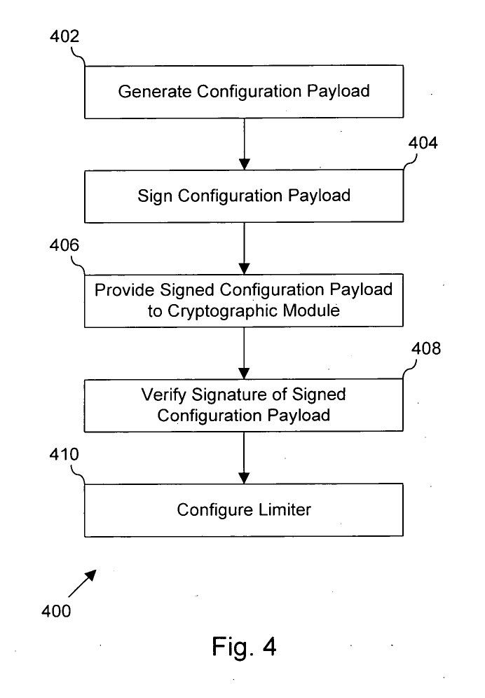

Process 300 may continue with the configuration of the limiter module for a first or initial mode [act 308]. FIG. 4 is a flow diagram illustrating a process 400 suitable for configuring a limiter module for a first mode in accordance with some implementations of act 308 of process 300. Process 400 may begin with the generation of a configuration payload [act 402]. In some implementations of the invention a configuration payload may include a set of data bits that control or specify the mode of operation of LM 214. For example, in some implementations of the invention, the configuration payload may specify the number of times that LM 214 will permit CE 210 to undertake cryptographic operations. The configuration payload may also specify the actions that LM 214 will undertake in response to CE 210 exceeding an operation limit (e.g., disable CE 210, etc.).

In some implementations of the invention, act 402 may be undertaken by having application 220 assemble data in the form of a configuration payload although the invention is not limited in this regard and act 402 may be undertaken ahead of time by another application. In accordance with act 308, the configuration payload may be designed to place LM 214 in a first mode where that mode may be, for example, a manufacture mode permitting a manufacturer of system 100/200 to have CE 210 undertake cryptographic processing in response to requests from a manufacturing validation application, such as application 220.

Process 400 may continue with signing of the configuration payload [act 404]. One way to do this is to have application 220 use portions of system 100/200, the manufacturer's private key of one of the key pairs generated in act 302, and well known PKI techniques to sign the payload generated in act 402. That signed payload may then be provided to the cryptographic module [act 406]. In some implementations, application 220 may use portions of system 100/200 (e.g., processor 102 and pathway 110) to convey the signed configuration payload to CM 202. Process 400 may then continue with the verification of the signature of the signed payload [act 408]. One way act 408 may be undertaken is to have configuration unit 216 of LM 214 use CE 210 and well known PKI techniques to verify the signed payload using the public key, stored in OTP 206, of the key pair corresponding to the private key used to sign the configuration payload in act 404.

Once verified as a valid configuration payload, process 400 may continue with the configuration of the limiter [act 410]. In some implementations, configuration unit 216 may respond to the contents of the configuration payload verified in act 408 by setting operation counter 218 with a specific initial or first operational count or limit. For example, the configuration payload may specify a limit to the number of cryptographic operations (i.e., encryption or decryption) that CE 210 may undertake. The configuration payload may also specify a time interval over which CE 210 may undertake cryptographic operations.

In response to that initial or first operation count or limit set or configured in act 410, LM 214 may use counter 218 to control the number of cryptographic operations that CE 210 may undertake in the first mode. Thus, for example, process 400 as an implementation of act 308 may result in CE 210 being limited to a specific number of cryptographic operations that CE 210 may undertake in response to requests from application 220. In other words, act 308 may result in CM 202 being capable of generating storage keys so that CE 210 may use the storage keys to encrypt secrets and to encrypt data with the secrets as many times a needed to support the manufacturing of system 100/200.

Returning to FIG. 3, process 300 may continue with the generation of a storage key [act 310], the encryption of a secret [act 312] using that storage key and the use of that secret to encrypt data [act 314]. In some implementations of the invention, CE 210 may undertake act 310 by having key generator 208 generate a storage key using root key 204 and well known cryptographic techniques, such as the Advanced encryption Standard (AES) algorithm. One way to undertake act 310 is to use CE 210 to encrypt a random number with the root key and then use the result as the storage key. CE 210 may then undertake act 312 by encrypting a secret provided by application 220 using well known cryptographic techniques and the storage key generated in act 310. CE 210 may also undertake act 314 by encrypting data provided by application 220 using well known cryptographic techniques and the secret provided by application 220.

Process 300 may then proceed with a determination of whether to exit the initial or first mode [act 316]. In some implementations, an application, such as application 220, may undertake the determination in act 316 and if the result of that determination is negative (i.e., that system 100/200 should remain in the first or initial mode) then acts 310-314 may repeat using a newly generated storage key and newly provided secrets or data.

If the result of act 316 is positive, in other words if the determination is to leave the initial or first mode, then process 300 may continue with the configuration of the limiter for a run-time or second mode [act 318]. Act 318 is similar to act 308 except that a different configuration payload is generated and used to configure the limiter. Thus, referring again to process 400 of FIG. 4, act 318 may, in some implementations of the invention, be undertaken by implementing acts 402-410 as described above except with a configuration payload formulated to have configuration unit 216 set or configure operation counter 218 with a specific second or run-time operation count or limit. For example, a manufacturer of system 100/200 may use act 318 to configure CM 202 so that CE 210 undertakes only a limited number of cryptographic operations as needed by system 100/200 in a second, run-time or commercial operation mode that places CE 210 under a new operational limit. Hence, in accordance with some implementations of the invention, act 318 may result in CM 202 being reconfigured such that CE 210 is limited to a second or run-time operational limit or count.

Process 300 may continue with the generation of a storage key [act 320], the encryption of a secret [act 322] with that storage key and/or encryption of data [act 324] with the secret. Acts 320-324 are similar to acts 310-314 except that acts 320-324 are undertaken using a newly generated storage key and a newly provided secret and/or data generated by and/or provided to CE 210 while CM 202 is operating in the second or run-time mode implemented by act 318. The description of acts 310-314 provided above may be referred to for further details of acts 320-324.

Process 300 may continue with a determination of whether the operational limit has been reached [act 326]. In some implementations, LM 214 may determine that CE 210 has undertaken sufficient cryptographic operations when counter 218 reaches the second or run-time limit that was set or configured in act 318. If the determination of act 326 is positive, that is, if, for example, counter 218 reaches the run-time limit, then a rest, halt and/or disable may be undertaken [act 328] as specified by the configuration payload provided in act 318. One way to do this may be to have LM 214 issue a disable signal preventing CE 210 from undertaking additional cryptographic operations. In other implementations, when CE 210 has reached the second or run-time limit LM 214 may issue a reset or halt or similar signal preventing processor 102 and/or other components of system 100 from continuing to operate thereby preventing CE 210 from undertaking cryptographic operations.

Process 300 may continue with a determination of whether to reconfigure the limiter [act 330]. While FIG. 3 shows act 330 occurring after act 328, the invention is not limited in this regard and act 330 may take place at any point after act 318. In other words, while act 330 may be undertaken, as shown, after an operational limit has been reached (act 326) and system 100/200 reset and/or components thereof, such as CE 210, disabled (act 328), act 330 may also be undertaken at any time while acts 320-324 are occurring or prior to act 326 occurring. One way to implement act 330 is to have application 220 determine that LM 214 should be reconfigured.

Process 300 may then continue with the configuration of the limiter for a new mode [act 332]. Act 332 is similar to acts 308 and 318 except that a different configuration payload is generated and used to configure the limiter. Thus, referring again to process 400 of FIG. 4, act 332 may be undertaken by implementing acts 402-410 as described above except with a configuration payload specifying that configuration unit 216 set or configure operation counter 218 with a new operational count or limit.

In some implementations, act 332 may be undertaken by an application, such as application 220, to revoke or change the storage keys or secrets by reconfiguring LM 214 with a new configuration payload that is digitally signed by the private key of the manufacturer of system 100/200. Thus, configuration unit 216 may verify the signature of the configuration payload using the manufacturer's public key stored in OTP 206 and then change its operating parameters to permit field re-programmability of previous encrypted storage keys and/or secrets. Thus, for example, a manufacturer of system 100/200 may use act 332 to configure CM 202 so that CE 210 undertakes only a limited number of cryptographic operations as needed by system 100/200 in a new operation mode.

While processes 300 and 400 have been described with respect to system 100/200 and CM 202 and components thereof, those skilled in the art will recognize that processes 300 and 400 can be implemented in the context of any device or system in order to limit misuse of that device or system's cryptographic engines against brute force attacks in accordance with the invention. Clearly, many schemes other than processes 300 and 400 may be implemented consistent with the scope and spirit of the invention. For example, in various implementations of the inventions the configuration payloads provided in acts 308, 318 or 332 may all specify different cryptographic operational limits or controls. Moreover, as discussed above with respect to act 308, configuration payloads in accordance with some implementations of the invention may specify a particular time interval over which a CE may undertake cryptographic operations. As those skilled in the art will recognize, the exact scheme employed may depend upon such things as the architecture used to implement processes such as process 300, memory constraints within such architectures etc. However, the structural details of such schemes are not limiting on the invention.

The acts shown in FIGS. 3 and 4 need not be implemented in the order shown; nor do all of the acts necessarily need to be performed. Also, those acts that are not dependent on other acts may be performed in parallel with the other acts. For example, act 312 and 314 may be undertaken in parallel. Moreover, some acts of processes 300 and/or 400 may be implemented in hardware and/or firmware (e.g., acts 310-314), while other acts may be implemented, at least in part, in software (e.g., acts 308, 318 and 332). Further, at least some of the acts in this figure may be implemented as instructions, or groups of instructions, implemented in a machine-readable medium.

While the foregoing description of one or more instantiations consistent with the claimed invention provides illustration and description of the invention it is not intended to be exhaustive or to limit the scope of the invention to the particular implementations disclosed. Clearly, modifications and variations are possible in light of the above teachings or may be acquired from practice of various implementations of the invention. Clearly, many other implementations may be employed to provide for enhancing cryptographic engines against attack consistent with the invention.

No device, element, act, data type, instruction etc. set forth in the description of the present application should be construed as critical or essential to the invention unless explicitly described as such. Also, as used herein, the article “a” is intended to include one or more items. Moreover, when terms or phrases such as “coupled” or “responsive” or “in communication with” are used herein or in the claims that follow, these terms are meant to be interpreted broadly. For example, the phrase “coupled to” may refer to being communicatively, electrically and/or operatively coupled as appropriate for the context in which the phrase is used. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. A method comprising:
limiting a cryptographic device to a first number of cryptographic operations; and
reconfiguring the cryptographic device to limit the cryptographic device to a second number of cryptographic operations.

2. The method of claim 1, wherein the cryptographic operations include decryption of an encrypted storage key.

3. The method of claim 1, wherein reconfiguring comprises providing a configuration payload to the cryptographic device, the configuration payload specifying the second number.

4. The method of claim 3, wherein the configuration payload further specifies changes to storage keys or secrets associated with the cryptographic device.

5. The method of claim 1, further comprising:
preventing the cryptographic device from undertaking further cryptographic operations if the cryptographic device exceeds the second number of cryptographic operations.

6. The method of claim 5, wherein preventing the cryptographic device from undertaking further cryptographic operations comprises one of disabling the cryptographic device, resetting a processor that supports the cryptographic device, or halting, at least in part, the operation of a system that supports the cryptographic device.

7. The method of claim 1, wherein limiting the cryptographic device to a second number of cryptographic operations includes limiting the cryptographic device to cryptographic operations within a time interval.

8. An apparatus comprising:
a cryptographic engine at least capable of encrypting data and decrypting data; and
a limiter coupled to the cryptographic engine, the limiter at least capable of limiting the number of cryptographic operations the cryptographic engine may undertake, wherein the limiter is configurable to limit the cryptographic engine to different numbers of cryptographic operations.

9. The apparatus of claim 8, wherein the cryptographic operations include decryption of an encrypted storage key.

10. The apparatus of claim 8, further comprising:
one time programmable memory for storing a public key to be used by the cryptographic engine.

11. The apparatus of claim 8, wherein the limiter includes an operation counter coupled to the cryptographic engine, the operation counter at least capable of counting the number of cryptographic operations undertaken by the cryptographic engine.

12. The apparatus of claim 8, wherein the limiter is further configurable to change storage keys or secrets associated with the cryptographic engine.

13. The apparatus of claim 8, wherein limiting the number of cryptographic operations the cryptographic engine may undertake comprises one of disabling the cryptographic engine, resetting a processor that supports the cryptographic engine, or halting, at least in part, the operation of a system that supports the cryptographic engine.

14. A system comprising:
a cryptographic engine at least capable of encrypting data and decrypting data;
a limiter coupled to the cryptographic engine, the limiter at least capable of limiting the number of cryptographic operations the cryptographic engine may undertake, wherein the limiter is configurable to limit the cryptographic engine to different numbers of cryptographic operations; and
a display processor at least capable of processing the decrypting data for display.

15. The system of claim 14, wherein the cryptographic operations include decryption of an encrypted storage key.

16. The system of claim 14, wherein the limiter includes an operation counter coupled to the cryptographic engine, the operation counter at least capable of counting the number of cryptographic operations undertaken by the cryptographic engine.

17. The system of claim 14, wherein the limiter is further configurable to change storage keys or secrets associated with the cryptographic engine.

18. The system of claim 14, further comprising:
one time programmable memory for storing a public key to be used by the cryptographic engine.

19. The system of claim 14, wherein limiting the number of cryptographic operations the cryptographic engine may undertake comprises one of disabling the cryptographic engine, resetting a processor that supports the cryptographic engine, or halting, at least in part, the operation of a system that supports the cryptographic engine.
